(19) United States
(12) Patent Application Publication
(10) Pub. No.: US 2005/0137053 A1
(43) Pub. Date: Jun. 23, 2005

(54) Gearless transmission and engine system

(76) Inventor: Victor W. Rodman, Orangevale, CA (US)

Correspondence Address: VICTOR W. RODMAN, P.O. BOX 114, ORANGEVALE, CA, 95662, US

(21) Appl. No.: 10/755,968

(22) Filed: Dec. 18, 2003

(51) Int. Cl. F16H 15/10

(52) U.S. Cl. 476/57

(57) ABSTRACT

The gearless transmission is a system that enables a smaller engine, whether it is electric or gasoline, to be used In an automobile or other machinery, such as lawn mowers, powered wheel chair or any system that needs the Advantage of the speed control wheel that enables the system to maximize the efficiency of power to the drive System of any product, one of the primary advantages of this system is that the total weight of the said transMission is reduced and thus making it possible to be used in a variety of systems.

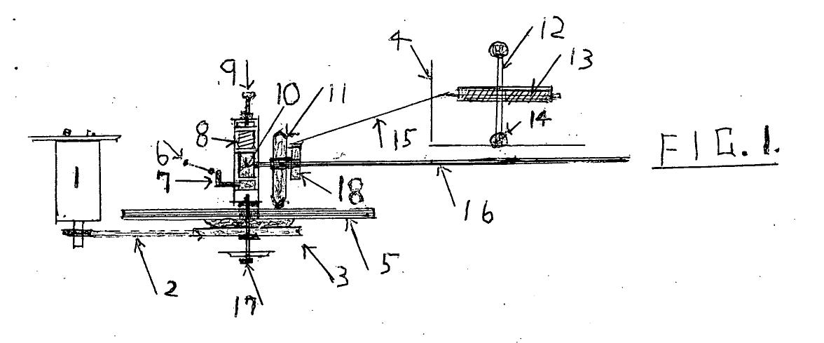

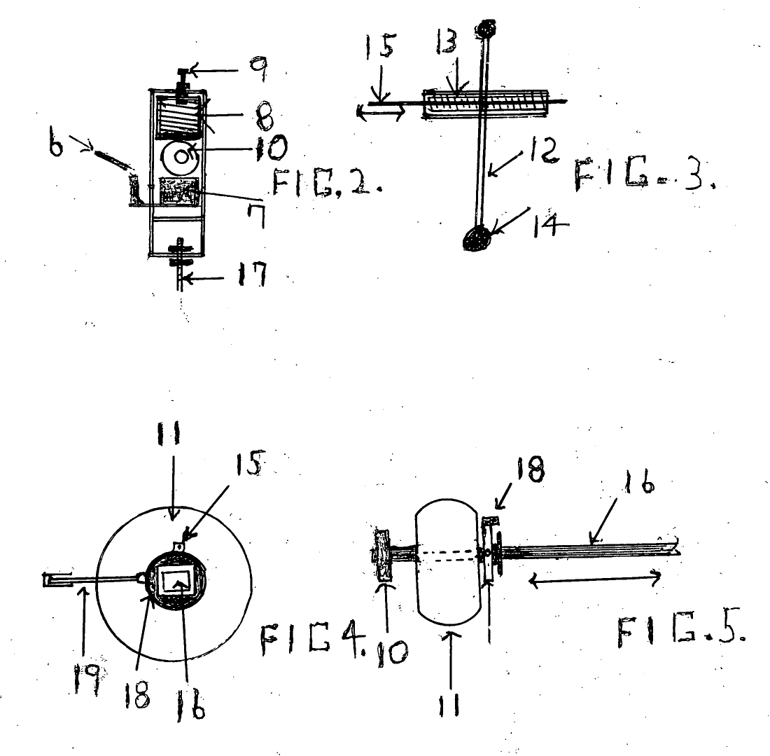

### BRIEF SUMMARY OF THE INVENTION

The gearless transmission is a system that has very few moving parts, and there fore requires less material to produce And in doing so, much energy such as coal or natural gas is saved, these are precious natural resources, also the Weight of the transmission, whether it is automatic or manual is reduced, and there for reduces need for heavy Front end suspension and also reduces wear on the front tires, a smaller motor is used and this also reduces the total Weight,

### BRIEF SUMMARY OF SEVERAL VIEWS OF THE DRAWINGS

1. Motor, which is of a golf cart type and has reversing features.
2. The V belt is the power source to the drive wheel.
3. The pulley is attached to the drive wheel.
4. Part of the frame
5. Primary drive wheel of system
6. Hydraulic unit that controls the cam, this is operated by the clutch pedal.
7. The cam is used to raise the speed control wheel up from the drive wheel, when there is an immediate need to Change the speed ratio between the motor and the drive shaft, or when you want to disengage the two units for any Reason.
8. Pressure control spring, this is used to maintain positive contact of speed control wheel and said drive wheel.
9. This screw is used to make proper adjustment to said spring.
10. Pilot bearing is assembled to end of drive shaft and is the unit that rests on the cam.
11. Speed control wheel.
12. Select shift lever is used to change motor to gear ratio.
13. Select shift springs, they let you change motor to gear ratio gradually, and when vehicle is picking up speed The select shift arm is pulled toward you, thus putting pressure on the spring, which in turn pulls the speed control Wheel towards the outer section of said wheel, the reverse is true when you are slowing down.
14. The stabilizing bushing is used to limit the free movement of the select shift lever
15. Control arm to select shift lever.
16. Drive shaft, this is the connecting unit between the speed control wheel and the drive unit.
17. Axle bolt, this is used to keep the drive wheel in alignment.
18. The thrust bearing is used to move the speed control wheel in either direction, and is used to obtain higher or Lower RPM of drive shaft.
19. The stabilizing arm is needed to limit the rotating movement of the thrust bearing.

### A SUMMARY OF THE FIGURES NUMBER 1, 2, 3, 4, AND 5

In figure number (1) this is a side view of the drive system.

In figure number (2) this is an enlarged view of the control spring, pilot bearing and the cam.

In figure number (3) this is an enlarged view of the select shift lever.

In figure number (4) this is an end view of the drive wheel, thrust bearing, stabilizing arm (19) and Drive shaft (16).

In figure number (5) this is an side view of the pilot bearing, drive wheel, thrust bearing (18) and the Drive shaft (16).

### DETAILED DESCRIPTION OF THE INVENTION

The process of making the said transmission is known in the field of manufacturing and each segment is prior art however some of the functions are of a new design. the said transmissions function allows Minute movement in the controls, and there fore there need not be any high RPM, between speed Changes, as there is in the prior art, this eliminates wear on engine parts and saves precious Fuel, that would other wise be wasted, this said transmission replaces the massive automatic and Manual units, the said transmissions function is controlled by using the Select Shift lever and by moving this lever fore ward or backward you are able to control the engine speed to the drive shaft Speed and there for, are able to maximize engine efficiently, efforts have been made in the industry to Maximize these efforts, but only to a small degree, all material used in the manufacture is available In the market place. this unit requires little or no regular maintenance. As compared to the prior art.

1. What I claim as my invention is a gearless transmission that has only two main moving parts, and they are the main Drive wheel and the speed control wheel, they are the primary functioning moving parts that operate the system, The speed control wheel is the unit that enables the operator to maximize the proficiency of the engine speed to The drive shaft speed, and thus making it possible to use a smaller motor, to accomplish what a larger motor would Be required to do, and by doing so, you save in every facet of manufacturing, operating and servicing the equipment And the cost will be reflected in the total cost of the finished product, the said transmission is designed to operate With a golf cart type electric motor
